(19) United States
(12) Patent Application Publication
(10) Pub. No.: US 2003/0228205 A1
(43) Pub. Date: Dec. 11, 2003

(54) Device for fastening molded or extruded plastics parts, more particularly to an automotive body by positive locking

(75) Inventors: Eckehard Hochholzer, Wangen (DE); Heinz-Jurgen Dieterle, Rothenbach (DE); Dirk Palicki, Hergensweiler (DE); Anton Sutter, Weiler-Simmerberg (DE)

Correspondence Address: Stephen B. Salai, Esq., Harter, Secrest & Emery LLP, 1600 Bausch & Lomb Place, Rochester, NY, 14604-2711, US

(73) Assignee: Metzeler Automotive Profile Systems GmbH, Lindau (DE)

(21) Appl. No.: 10/454,957

(22) Filed: Jun. 5, 2003

(30) Foreign Application Priority Data
Jun. 5, 2002 (DE) 102 24 973.3

(51) Int. Cl. F16B 19/00

(52) U.S. Cl. 411/508

(57) ABSTRACT

A device for fastening molded or extruded plastics parts, more particularly to an automotive body, by positive locking, comprising a base section joinable to the plastics part to be fastened and a retaining section adjoining the base section in a fastening direction. For forming a contact face, the retaining section protrudes beyond the base section perpendicular to the fastening direction. The base section and retaining section are made of elastically deformable material, at least the retaining section comprising a cavity. Such a device is characterized by the deformability of the retaining section being adaptable to the particular application in each case by relatively simple ways and means. The reason for this is that at least one elastically deformable partition is arranged in the cavity. The partition is configured as a through-hole extending in a normal direction perpendicular to the fastening direction and extends in a plane oriented perpendicular to the normal direction.

### CROSS-REFERENCE TO RELATED APPLICATIONS

This application claims priority of German Patent Application Number 102 24 973.3, filed Jun. 5, 2002.

### STATEMENT REGARDING FEDERALLY SPONSORED RESEARCH OR DEVELOPMENT

Not Applicable

### REFERENCE TO A “SEQUENCE LISTING”

Not Applicable

### BACKGROUND OF THE INVENTION

1. Field of the Invention

The invention relates to a device for fastening molded or extruded plastics parts, more particularly to an automotive body, by positive locking. The device comprises a base section joinable to the plastics part to be fastened and with a retaining section adjoining the base section in a fastening direction. For forming a contact face the retaining section protrudes beyond the base section perpendicular to the fastening direction. The base section and retaining section are made of elastically deformable material and comprise a cavity.

2. Background Art

Such a device, also termed in general a mushroom fastener, serves as a means for simply securing an injection molding or extruded plastics part, especially plastics parts made of vulcanizable or thermoplastic elastically deformable materials. For this purpose, the mushroom fastener joined to the plastics part to be fastened is inserted into an opening of a component—for example, an automotive body frame—which although featuring a larger diameter than the base section, has a smaller diameter than the retaining section protruding beyond the base section. The retaining section is thus squeezed together on being inserted into the opening to open out again after having passed through the opening such that the contact face formed on the retaining section clasps behind the opening at the side facing away from the plastics part to be fastened. It is in this way that a positive connection materializes holding the plastics part in place.

How effective the resulting positive connection is, depends primarily on the size of the contact face. The larger the contact face clasping behind the opening, the higher the force that is needed to pull the retaining section from the opening. The effectiveness of the positive connection is also influenced by the rigidity exhibited by the retaining section. In addition to the material it is also the geometry of the retaining section that dictates this rigidity. Mushroom fasteners in the aforementioned sense as are known, for example, from DE 85 34 283 U1 for securing an extruded glazing weatherseal and from DE 43 08 215 C1 for securing a sliding roof weatherseal comprise a cavity configured as a through-hole which reduces the rigidity of the retaining section. It is due to this reduction in the rigidity because of providing the cavity that although it reduces the force needed the release the positive connection it adds to the deformability of the retaining section. It is especially with mushroom fasteners made of a relatively hard material, such as, for example, a thermoplastic elastomer (TPE) that there is a risk of them becoming plastically deformed because of this inadequate deformability, detrimenting the effectiveness of the positive connection. Accordingly, as a rule, providing a cavity to enhance the deformability of the retaining section is a mandatory requirement.

The drawback discovered with these known mushroom fasteners is that the rigidity and thus the deformability of the retaining section for an effective positive connection, on the one hand, and to facilitate assembly, on the other, are difficult to adapt to any particular application. Specifying a certain material, for instance when the retaining section is configured integrally with the plastics part to be fastened represents another limitation, which reduces the possibilities of varying the deformability of the retaining section.

### BRIEF SUMMARY OF THE INVENTION

The invention is based on the objective of sophisticating a device of the aforementioned kind so that the deformability of the retaining section can now be adapted to any particular application by relatively simple ways and means.

To achieve this objective it is provided for in the device having the features in accordance with the invention as cited above that at least one elastically deformable partition is arranged in the cavity.

The gist of a device configured as such is that the partition arranged in the cavity positively influences the rigidity and thus the deformability of the retaining section. By varying the thickness and size of the partition, as is simple to achieve in fabrication, the deformability of the retaining section can be varied in adapting it to the particular application in each case. In addition, the partition is a design aspect which is easy to correlate with the configuration of the contact face of the retaining section in defining the force needed to release the positive connection, for instance.

Advantage aspects of the device in accordance with the invention read from the claims 2 to 11.

Thus, it is of advantage in achieving a relatively high deformability to configure the cavity as a through-hole passing through the base section and retaining section in a normal direction perpendicular to the fastening direction. By configuring the cavity in both the retaining section and in the base section the mushroom fastener in accordance with the invention can be easily squeezed together for insertion into an opening, this also being assisted by the cavity expediently being a through-hole oriented in the normal direction.

It is furthermore of advantage when the partition extends in a plane oriented perpendicularly to the normal direction. In this case, the partition can be oriented in a longitudinal centerline of the device in accordance with the invention so that when being squeezed together the partition is pliantly kinked, characterized by a comparatively high moment of resistance. It is in this way that the deformability of the retaining section is dictated mainly by the thickness of the partition in the fastening direction.

Preferably the through-hole is defined by a top wall of the retaining section. The top wall contributes towards rendering the retaining section more rigid definedly such that the contact face securely contacts a surface area surrounding an opening receiving the retaining section.

To advantage the partition is spaced away from the top wall by a gap. This gap makes it possible to deform the partition and the top wall each separately from the other. Separating the one from the other in this way in design ensures systematically adapting the deformability of the retaining section by varying the thickness of the partition. For this purpose it is furthermore of advantage to space the partition from the plastics part to be fastened by a gap.

In one preferred embodiment of the device in accordance with the invention the retaining section includes a shell wall conically tapered in the fastening direction. This shell wall rendering the retaining section more or less in the shape of a truncated cone, for example, facilitates inserting a component into the opening to which the plastics part is to be fastened.

It is furthermore provided for in another preferred embodiment of the device in accordance with the invention that the contact face is slanted to the fastening direction. Configuring the contact face slanted facilitates releasing the positive connection in thus promoting disassembly for recycling.

To ensure ease of handling in assembly the device in accordance with the invention the base section and the retaining section are preferably configured more or less circular in cross-section.

For simple and cost-effective fabrication, base section and retaining section are configured integrally and preferably produced by injection molding in another advantageous aspect of the device in accordance with the invention. The mushroom fastener thus configured as a molding permits facilitated deformability in the normal direction so that even when lack of accuracy in fabrication exists an accurate geometry of base section and retaining section is ensured in the fastening direction as necessary for a reliable fastening.

In conclusion, a one-piece configuration of the device in accordance with the invention with the plastics part to be fastened thereby is proposed to advantage. Configuring the mushroom fastener integrated ensures simple practical assembly of the plastics part unlike separate clip fasteners, for instance.

### BRIEF DESCRIPTION OF THE SEVERAL VIEWS OF THE DRAWING(S)

The device in accordance with the invention will now be detailed with its further advantages by a description of two preferred embodiments with reference to the drawings showing the embodiments merely diagrammatically and in which:

FIG. 1 is a section taken through a mushroom fastener along the line I-I in FIG. 2a;

FIG. 2a is a section taken through a mushroom fastener as shown in FIG. 1 along the line II-II in FIG. 1 and

FIG. 2b is an illustration of an alternative embodiment of the mushroom fastener as shown in FIG. 2a.

### DETAILED DESCRIPTION OF THE INVENTION

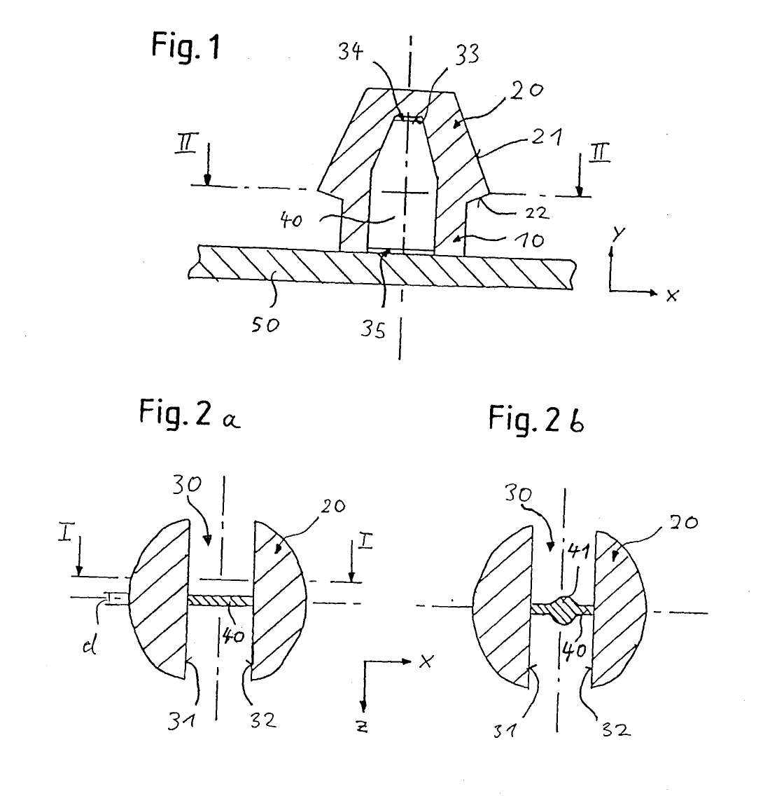

Referring now to FIG. 1 there is illustrated a device made of a elastically deformable material for fastening a molding made of a plastics material by positive locking, for example EPDM or TPE. The device represents a mushroom fastener comprising a base section and a retaining section joinable in a fastening direction. The base section and the retaining section are configured cross-sectionally more or less circular and are fabricated integrally by injection molding with the molding.

As evident furthermore from FIG. 1 the retaining section has substantially the shape of a truncated cone formed by the shell wall being conically tapered in the fastening direction. The shell wall translates at the widest diameter of the retaining section into a contact face facing the molding and oriented slanting to the fastening direction.

The base section and the retaining section are in addition provided with a cavity configured as a through-hole extending in a normal direction perpendicular to the fastening direction. Referring now to FIGS. 2a and 2b it is particular evident how arranged in the through-hole is an elastically deformable partition extending in a plane oriented perpendicular to the normal direction, i.e. in the fastening direction and a transverse direction perpendicular thereto. The partition comprises a thickness in the normal direction and is oriented between two side walls forming the through-hole. In the present case, the partition is spaced away from a top wall defining the through-hole by a gap. Comprising the gap between partition and top wall is optional and is simply achievable; for example, by nicking the injection molded mushroom fastener. In addition, the partition is spaced away from the molding by a gap likewise providable optionally. The gaps enable the partition to deform independently of the top wall and the molding when the retaining section is squeezed together in the transverse direction.

The mushroom fastener as described above permits positive connection of the molding to another component, for example, to a metal automotive body frame. For this purpose the retaining section is inserted into an opening in the component having a diameter slightly larger than the diameter of the base section and smaller than the largest diameter of the retaining section in the region of the transition of the shell wall into the contact face. When the retaining section is inserted into the opening, the contact face clasps behind a surface area of the component facing away from the molding and surrounding the opening, resulting in a positive connection.

To permit inserting the retaining section into the opening of the component the mushroom fastener needs to be deformed at least in the transverse direction. The deformability of the mushroom fastener in this arrangement is primarily determined by the configuration of the partition, more particularly its thickness. The greater the thickness the higher is the rigidity of the mushroom fastener in the transverse direction. In addition to this, the rigidity can be adapted by a particular configuration of the partition, for example by means of a thickening, as evident from FIG. 2b. Configuring the partition is simple to vary in fabrication to attain a deformability of the retaining section optimized in each case, depending on the application. Last but not least, there is the possibility of varying the rigidity and thus the deformability of the retaining section by correspondingly configuring the partition, a means of standardization ensuring rational and cost-effective fabrication.

1. A device for fastening molded or extruded plastics parts, more particularly to an automotive body, by positive locking, comprising a base section joinable to said plastics part to be fastened, and a retaining section adjoining said base section in a fastening direction, said retaining section protruding beyond said base section perpendicular to said fastening direction for forming a contact base, said base section and said retaining section being made of an elastically deformable material, and at least said retaining section comprising a cavity which includes at least one elastically deformable partition being arranged in said cavity, which is configured as a through-hole extending in a normal direction perpendicular to said fastening direction, said partition extending in a plane oriented perpendicular to said normal direction.

2. The device of claim 1 in which said retaining section has a top wall restricting said through-hole.

3. The device of claim 2 in which said partition is spaced away from said top wall by a gap.

4. The device of claim 1 in which said through-hole is passing through said base section and said retaining section.

5. The device of claim 4 in which said partition is spaced away from said plastics part to be fastened by a gap.

6. The device of claim 1 in which said retaining section includes a shell wall conically tapered in said fastening direction.

7. The device of claim 1 in which said contact face is slanted to said fastening direction.

8. The device of claim 1 in which said base section and said retaining section are approximately circular in cross-section.

9. The device of claim 1 in which said base section and said retaining section are configured in one-piece.

10. The device of claim 1 in which said base section and said retaining section are produced by injection molding.

11. The device of claim 1 having a one-piece configuration with said plastics part to be fastened thereby.
